(19) United States
(12) Patent Application Publication
(10) Pub. No.: US 2008/0004360 A1
(43) Pub. Date: Jan. 3, 2008

(54) Polyarylene Polymer And Use Thereof

(75) Inventors: Takashi Yamada, Ibaraki (JP); Toru Onodera, Ibaraki (JP); Shigeru Sasaki, Ibaraki (JP)

Correspondence Address: FOLEY AND LARDNER LLP;SUITE 500, 3000 K STREET NW, WASHINGTON, DC, 20007, US

(73) Assignee: Sumitomo Chemical Company, Limited, Tokyo (JP)

(21) Appl. No.: 11/547,136

(22) PCT Filed: Apr. 1, 2005
(86) PCT No.: PCT/JP05/06892

§ 371 Date: Oct. 4, 2006

(30) Foreign Application Priority Data
Apr. 6, 2004 (JP) 2004-111830

(51) Int. Cl. H01B 1/06; C08G 61/10; H01M 4/86; H01M 8/02; H01M 8/10

(52) U.S. Cl. 521/27; 521/25

(57) ABSTRACT

Disclosed is a polyarylene polymer having a specific structure which exhibits excellent performance as a proton conductive membrane for solid polymer fuel cells or the like.

### TECHNICAL FIELD

The present invention relates to a polyarylene polymer, and relates to a polyarylene polymer preferably used for a polymer electrolyte, in particular, for fuel cells and use thereof.

### BACKGROUND ART

A polymer having proton conductivity, namely polymer electrolyte is used as the separating membrane of electrochemical devices such as primary cells, secondary cells and solid polymer fuel cells. For example, when polymer electrolytes having an aliphatic polymer having perfluoroalkylsulfonic acid being ultra strong acid at side chains whose main chain is perfluoroalkane such as NAFION (Registered Trade Mark of EI DuPont de Nemours & Company) are used as a membrane material for fuel cells or an ion exchange component, they have been conventionally used mainly because of the superior generation property of electricity of fuel cells obtained. However, it has been indicated that the material is very expensive, heat resistance is low, membrane strength is low and reinforcement is required.

Under these circumstances, the development of a polymer electrolyte with low price and superior in performance that replaces the above-mentioned polymer electrolytes has been recently activated and polyarylene polymer electrolytes having polyphenylene in a main chain structure have been studied.

For example, there are proposed a polyarylene polymer electrolyte (U.S. Pat. No. 5,403,675) which has a phenylene unit having a substituent as a repeating unit and in which the substituent is an aromatic group having a sulfonic acid group at terminal such as a sulfophenoxybenzoyl group, a polyarylene polymer electrolyte (Japanese Unexamined Patent Application Publication No. 2001-342241) which has a phenylene unit having a substituent similar as the above-mentioned substituent, a benzophenone unit and the like.

### DISCLOSURE OF THE INVENTION

However, when the above-mentioned polyarylene polymer electrolyte is used for solid polymer fuel cells, it is not adequately satisfied level from the viewpoints of physical properties such as the temperature and humidity dependency of electricity generating property, water resistance and solvent resistance; mechanical properties such as tensile property, flexibility and elasticity in a membrane form; process ability at the preparation step of a membrane-electrode assembly and the like and more improvement has been expected.

The present inventors have intensively studied in order to find a more superior polymer as a polymer electrolyte for fuel cells or the like, as a result, have found that when a polyarylene polymer which has a phenylene group having an aliphatic group with a sulfonic acid group at terminal as a repeating unit is used as a polymer electrolyte, in particular, a proton conductive membrane for solid polymer fuel cells, it exhibits excellent performance in proton conductivity and the like and have studied further variously to complete the present invention.

Namely, the present invention is
[1] a polyarylene polymer having a repeating unit represented by the following general formula (1) 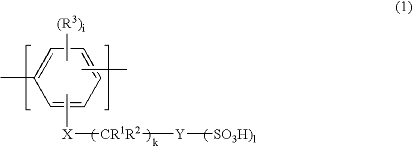
(Wherein X represents any of a direct bond, —O—, —S—, —SO—, —SO₂— or —CO—, Y represents a direct bond, a divalent aromatic group or trivalent aromatic group, R¹ and R² represent mutually a hydrogen atom or a fluorine atom independently, R³ represents a sulfonic acid group, an alkyl group having 1 to 10 carbons or an aryl group having 6 to 18 carbons which may be optionally substituted, i represents a number of 0 to 3, k represents a number of 1 to 12, l represents 1 when Y is a direct bond or divalent and l represents 2 when Y is a trivalent aromatic group.),
[2] the polymer according to the above-mentioned [1], wherein 90% or more of the repeating unit represented by the general formula (1) is bonded with the repeating units at both adjacent side at para-position,
[3] the polymer according to the above-mentioned [1] or [2], further having at least one of repeating units represented by the following general formulae (2) and (3) 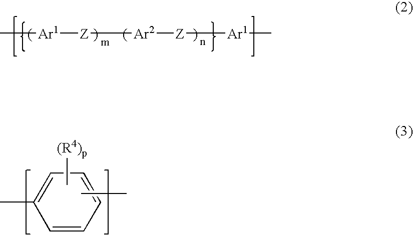
(Wherein Ar¹ and Ar² represent a divalent aromatic group independently, wherein the divalent aromatic group may be optionally substituted with an alkyl group having 1 to 10 carbons, an aryl group having 6 to 18 carbons or a sulfonic acid group, Z represents any of —O—, —SO₂— or —CO—, m represents a number of 1 or more, n represents a number of 0 or more, R⁴ represents a sulfonic acid group, an alkyl group having 1 to 10 carbons, an aryl group having 6 to 18 carbons which may be optionally substituted or an acyl group having 2 to 20 carbons independently and p represents a number of 0 to 4.),
[4] the polymer according to the above-mentioned [3], wherein 90% or more of the repeating unit represented by the general formula (3) is bonded with the repeating units at both adjacent side at para-position,
[5] the polymer according to any of the above-mentioned [1] to [4], wherein Y is a direct bond,
[6] a polymer according to any of the above-mentioned [1] to [5], wherein i is 0,
[7] the polymer according to any of the above-mentioned [1] to [6], wherein ion exchange capacity is from 0.5 meq/g to 4 meq/g,
[8] the polymer according to any of the above-mentioned [1] to [7], being a random copolymer or a block copolymer,
[9] a polymer electrolyte wherein the polymer according to any one of the above-mentioned [1] to [8] is an effective component,
[10] a polymer electrolyte membrane comprising the polymer electrolyte according to the above-mentioned [9],
[11] a catalyst composition comprising the polymer electrolyte according to the above-mentioned [9], and
[12] a polymer electrolyte fuel cell comprising at least one selected from the polymer electrolyte according to the above-mentioned [9], the polymer electrolyte membrane according to the above-mentioned [10] and the catalyst composition according to the above-mentioned [11].

The polyarylene polymer of the present invention exhibits excellent performance in properties such as proton conductivity as a polymer electrolyte, in particular, proton conductive membrane for solid polymer fuel cells. As a result, when it is used as the proton conductive membrane for solid polymer fuel cells, it is considered that it exhibits the high generation property of electricity and the polyarylene polymer of the present invention is industrially advantageous as the polymer electrolyte.

### MODE FOR CARRYING OUT THE INVENTION

The present invention will be described in detail below.

The polyarylene polymer of the present invention is characterized in having the repeating unit indicated by the above-mentioned general formula (1).

Herein, —X— in the formula (1) represents any of a direct bond, —O—, —S—, —SO—, —SO₂— or —CO—, but among these, —O—, —SO₂— and —CO— are preferable.

Further, Y represents a direct bond, a divalent aromatic group or trivalent aromatic group, and in case of an aromatic group, its carbon number is usually about 6 to 18, which is derived from an aromatic ring which may optionally have a substituent. Examples of the aromatic ring which may optionally have a substituent includes a benzene ring, a naphthalene ring, those in which these groups are substituted with a fluorine atom, methoxy, ethoxy, isopropoxy, biphenylyl, phenoxy, a naphthyloxy group or the like. As the preferable example, groups below are mentioned when they are represented by including a sulfonic acid group and Y is preferably a direct bond in particular. 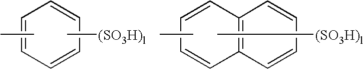
(Wherein 1 represents the same meaning as above.)

R¹ and R² represent a hydrogen atom or a fluorine atom independently, but a case that they are a hydrogen atom together or a fluorine atom together is preferable.

Further, R³ represents a substituent on phenylene in a polymer main chain and represents a sulfonic acid group, an alkyl group having 1 to about 10 carbons or an aryl group having 6 to about 18 carbons which may be optionally substituted.

Examples of the alkyl group having 1 to about 10 carbons include methyl, ethyl, n-propyl, isopropyl, n-butyl, sec-butyl, iso-butyl, n-pentyl, 2,2-dimethylpropyl, cyclopentyl, n-hexyl, cyclohexyl, 2-methylpentyl, 2-ethylhexyl, nonyl and the like. Examples of the aryl group having 6 to about 18 carbons which may be optionally substituted include a phenyl group, a naphthyl group, those in which these groups are substituted with a fluorine atom, methoxy, ethoxy, isopropyloxy, biphenylyl, phenoxy, naphthyloxy, a sulfonic acid group and the like.

i is the number of R³ substituted and represents a number of 0 to 3, and it is preferable that i is 0 or R³ is methyl and ethyl. k represents a number of 1 to 12, but is preferably 2 to 6. l represents 1 when Y is a direct bond or divalent aromatic group and l represents 2 when Y is a trivalent aromatic group.

Further, phenylene in the main chain of a polymer is bonded with other repeating unit at an ortho position, a meta position and a para position and although all is not required to be the same bond position, it is preferable that 90% or more of the repeating unit is bonded with the repeating units at both adjacent sides at a para position.

Examples of the repeating unit represented by the general formula (1) include those below.

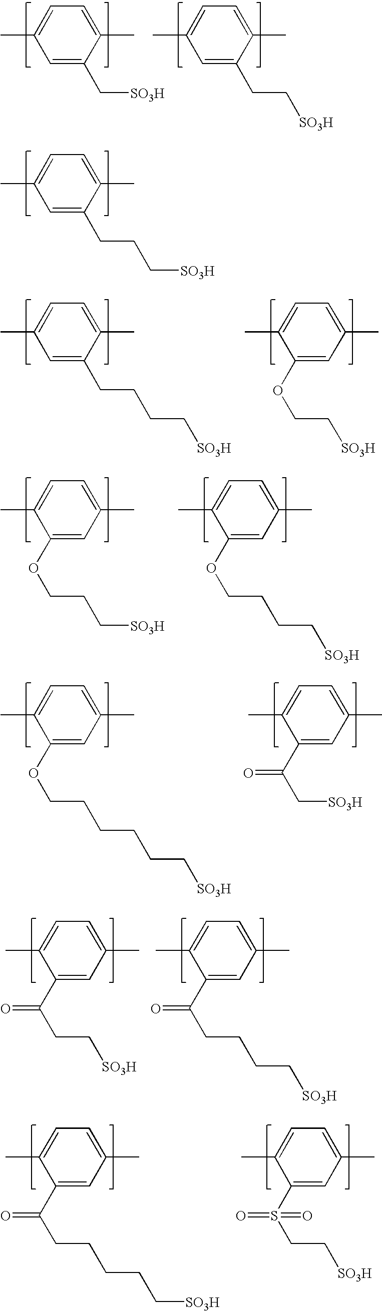

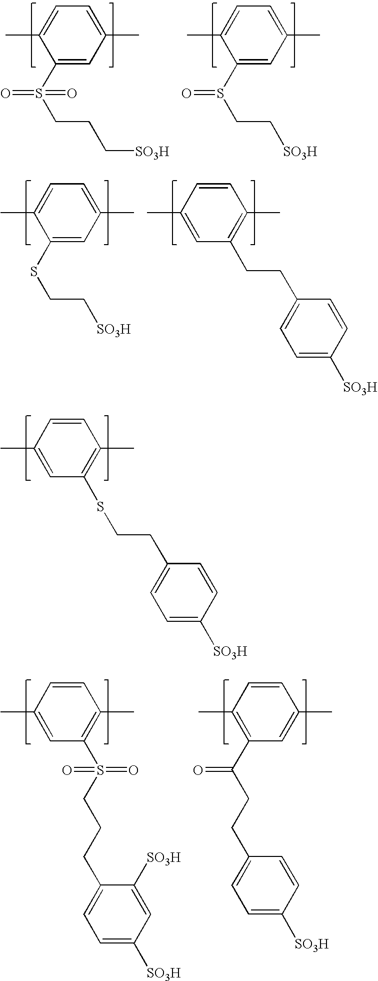

The polyarylene polymer of the present invention is characterized in having the repeating unit represented by the above-mentioned general formula (1) as described above. The polyarylene polymer of the present invention includes also those in which a portion or all of sulfonic acid groups are a salt form. The example includes the salt of alkali metal or the salt of alkali earth metal such as lithium salt, sodium salt, calcium salt and potassium salt. Further, when it is used as a material for the solid polymer fuel cells, it is preferable that all of sulfonic acid groups in the polyarylene polymer are essentially free acid form.

Further, in addition to the repeating unit represented by the general formula (1) as above, the polyarylene polymer of the present invention may have a repeating unit different from this.

For example, it is preferable to have further the repeating units represented by the general formulae (2), (3) and the like.

Herein, Ar¹ and Ar² in the general formula (2) represent a divalent aromatic group independently. The divalent aromatic group is preferably a divalent group derived from an aromatic ring and a divalent group with which two aromatic rings are linked directly or a connecting member. Examples of the divalent aromatic group include divalent groups below.

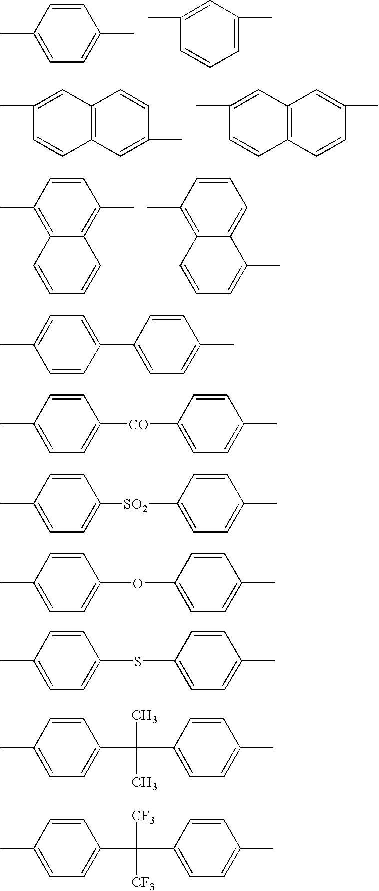

The aromatic rings of Ar¹ and Ar² of the divalent groups including the above groups may have as a substituent, an alkyl group having 1 to about 10 carbons such as methyl, ethyl, n-propyl, isopropyl, n-butyl, sec-butyl, tert-butyl, iso-butyl, n-pentyl, 2,2-dimethylpropyl, cyclopentyl, n-hexyl, cyclohexyl, 2-methylpentyl, 2-ethylhexyl, nonyl and decyl; aryl groups having 6 to about 18 carbons such as a phenyl group, a naphthyl group, those in which these groups are substituted with a fluorine atom, methoxy, ethoxy, isopropyloxy, biphenylyl, phenoxy and naphthyloxy, and the like, a sulfonic acid group and the like, but they have preferably a sulfonic acid group or no substituent.

Further, Z represents any of —O—, —SO₂— or —CO—, but a plural Z's are optionally different each other. m represents a number of 1 or more, n represents a number of 0 or more and m+n is preferably a number of 1 to 1000.

Typical examples of the repeating unit represented by the general formula (2) include those below. m and n represent the same meaning as above.

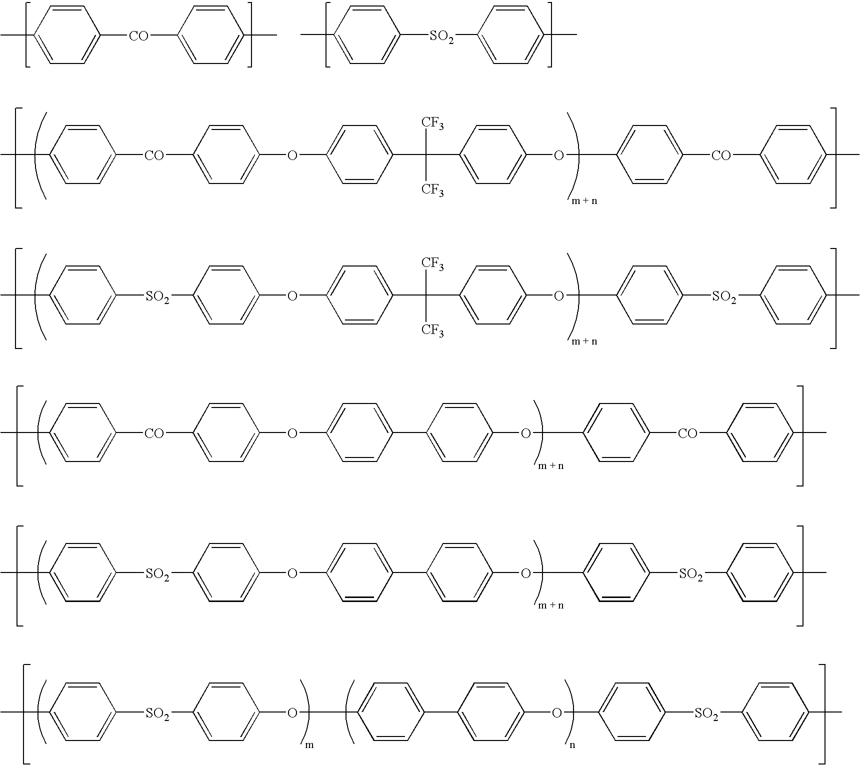

Further, R⁴ in the general formula (3) represents a substituent on a benzene ring and represents mutually a sulfonic acid group, an alkyl group having 1 to about 10 carbons, an aryl group having 6 to about 18 carbons or an acyl group having 2 to about 20 carbons independently.

Here, Examples of the alkyl group having 1 to about 10 carbons and the aryl group having 6 to about 18 carbons include an alkyl group and an alkyl group similar as above. Further, Examples of the acyl group having 2 to about 20 carbons include acetyl, propionyl, butyryl, isobutyryl, benzoyl, 1-naphthoyl, 2-naphthoyl, acyl groups in which these groups are substituted with a fluorine atom, methoxy, ethoxy, isopropyloxy, biphenylyl, phenoxy, naphthyloxy, a sulfonic acid group and the like. Among these, R⁴ is preferably benzoyl and phenoxybenzoyl. p is the number of R⁴ substituted and represents a number of 0 to 4. P is preferably 0.

Further, phenylene in the general formula (3) is bonded at an ortho position, a meta position and a para position and although all is not required to be the same bond position, it is preferable that 90% or more of the repeating unit is bonded with the repeating units at both adjacent sides at a para position.

Typical examples of the repeating unit represented by the general formula (3) include those below.

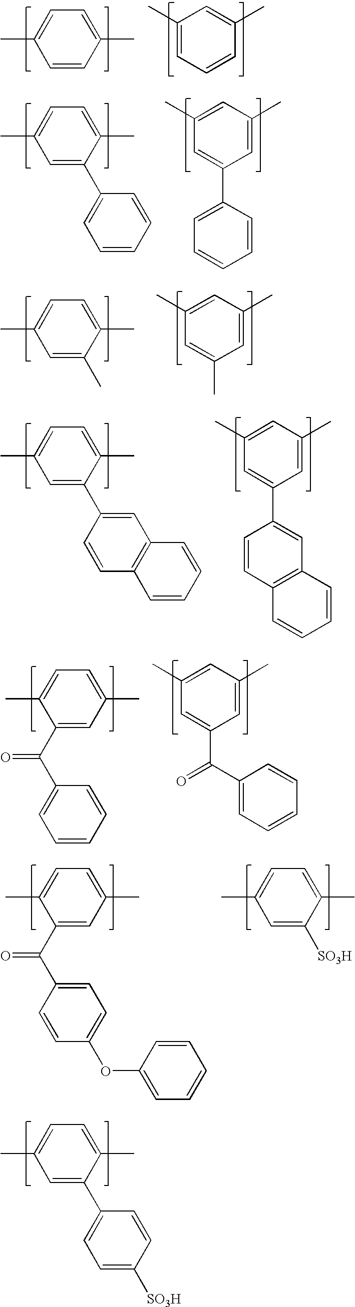

The polyarylene polymer of the present invention may have the repeating unit represented by the above-mentioned general formula (2) and/or the general formula (3) in addition to the repeating unit represented by the above-mentioned general formula (1), but the composition ratio of these is preferably a composition ratio by which the introducing degree of an acid group is 0.5 meq/g to 4 meq/g that is represented by ion exchange capacity. When the ion exchange capacity is lower than 0.5, proton conductivity becomes low and function as the polymer electrolyte for fuel cells is occasionally inadequate. The lower limit of the ion exchange capacity is preferably 1.0 or more and preferably 1.5 or more in particular.

Further, when ion exchange capacity exceeds 4, water resistance is occasionally lowered. The upper limit of the ion exchange capacity is preferably 3.8 or less and preferably 3.5 or less in particular.

Further, for example, when it has the repeating unit represented by the above-mentioned general formula (2) and/or the general formula (3) and the like other than the repeating unit represented by the general formula (1), it may be a random copolymer in which the linkage mode of these, namely copolymerization mode is random, a block copolymer in which it is repeated in block, or a combination thereof.

In case of a random copolymer, (m+n) is preferably 1 or 2 as the general formula (2). Further, in case of a block copolymer, it has a block in which the general formula (1) and the general formula (2) and/or the general formula (3) are singly repeated respectively, but the repeating number is preferably 10 to 100 incase of the general formula (1), (m+n) is preferably 10 to 100 in case of the general formula (2) and it is preferably 10 to 200 in case of the general formula (3).

The molecular weight of the polyarylene polymer of the present invention is preferably 5000 to 1000000 that is represented by number average molecular weight converted to polystyrene and preferably 1500 to 400000 in particular.

As typical examples of a case having the repeating unit represented by the above-mentioned general formulae (2), (3) and the like, for example, those below are exemplified. Here, the repeating number of respective repeating units is abbreviated, but the repeating number satisfying the ion exchange capacity, composition ratio, block length, molecular weight and the like which are described above is preferable.

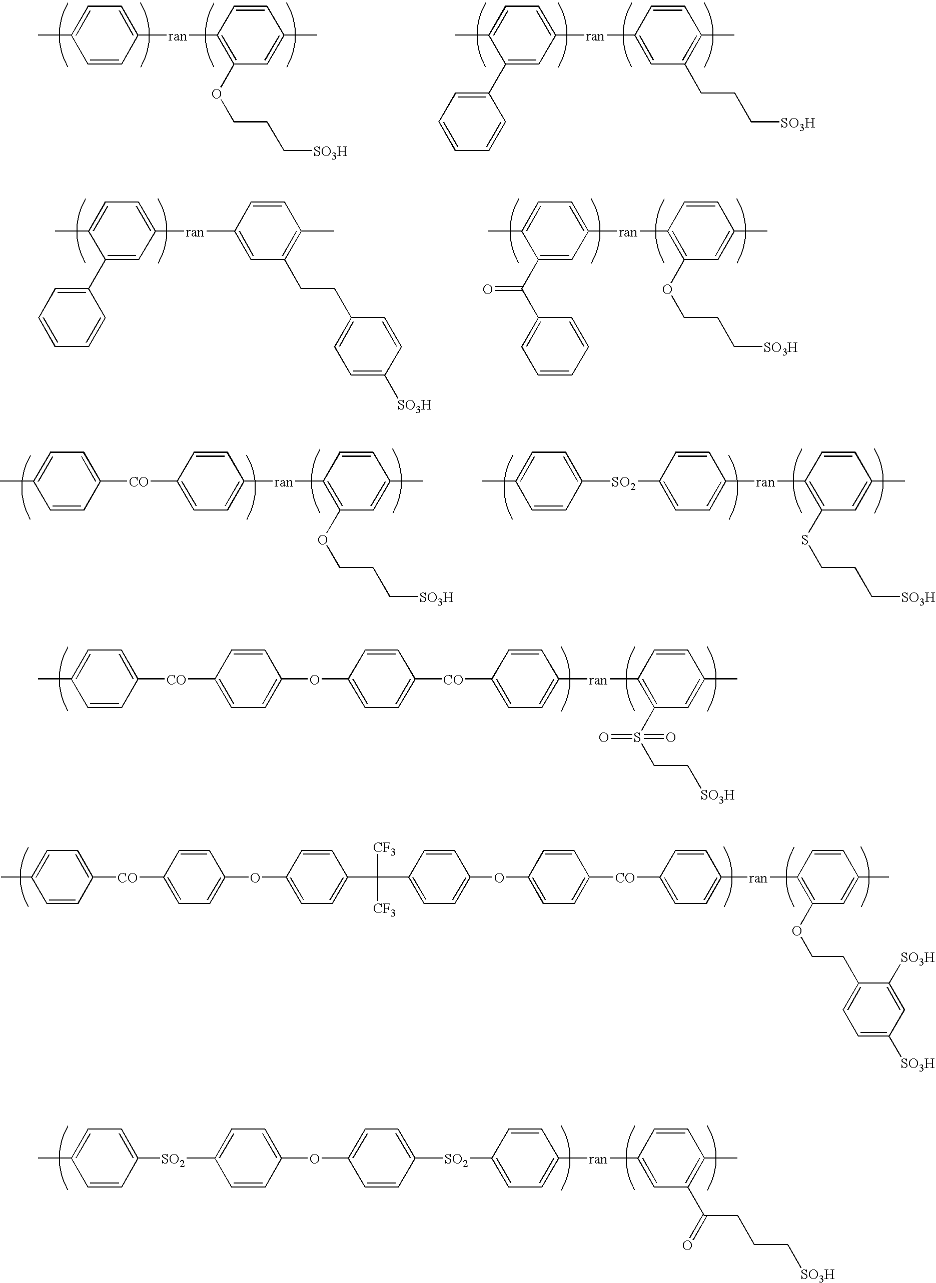

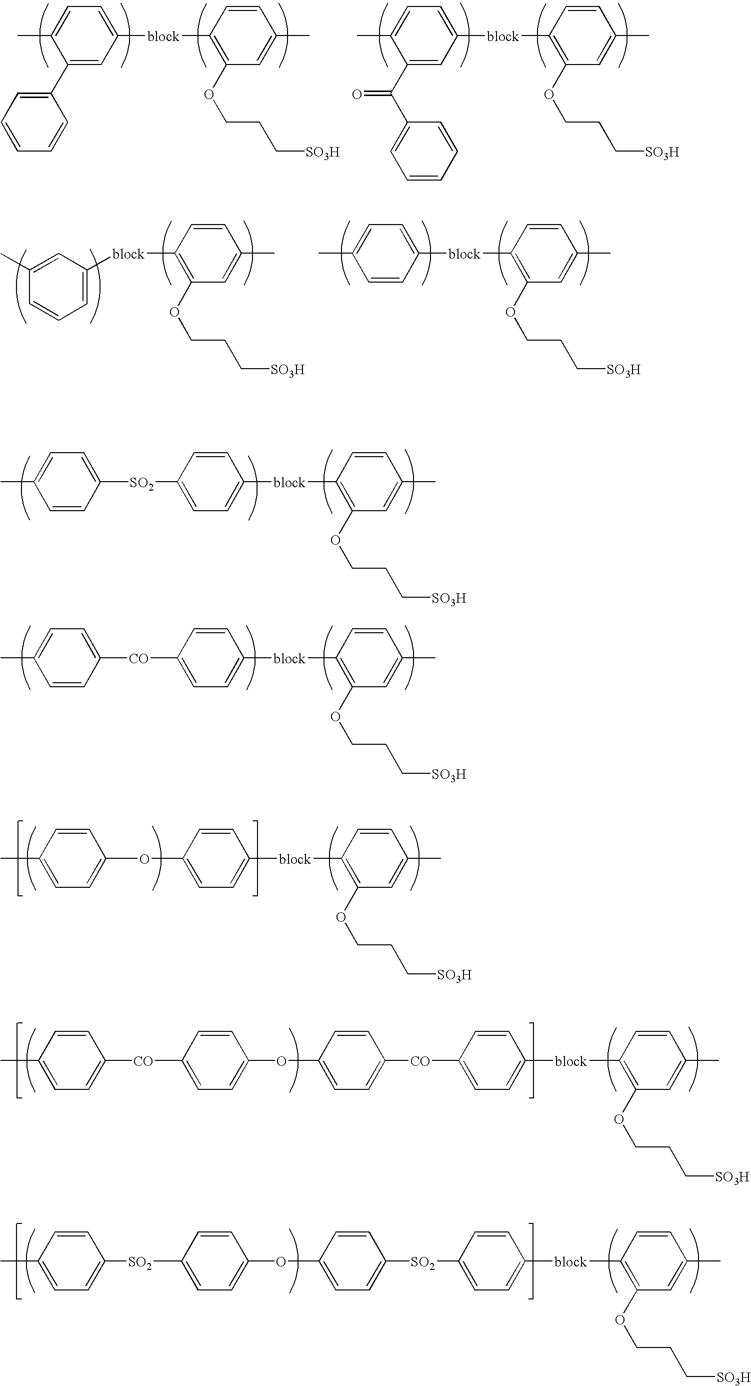

Then, the manufacturing process of the polyarylene polymer of the present invention will be described.

The polyarylene polymer of the present invention can be produced, for example, by polymerizing a monomer i represented by the general formula (4) and monomers represented by the general formulae (5) and (6) which are used if necessary, in the coexistence of a zero valent transition metal complex by condensation reaction. 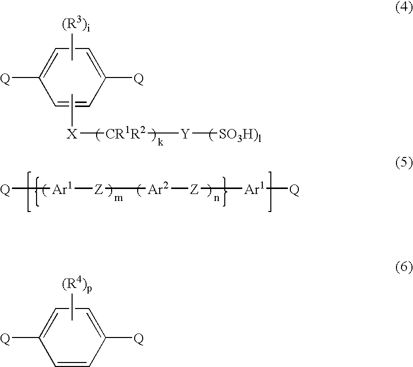
(Wherein Ar¹, Ar², R¹ to R⁴, X, Y, i, k, m, n, l and p have the same meaning as above. Q represents a group eliminating at condensation reaction and a plural number of Q's may be different kind.)

Herein, Q represents a group eliminating at the condensation reaction and its specific example includes halogen groups such as chloro, bromo and iodo, sulfonic acid ester groups such as a p-toluenesulfonyloxy group, a methanesulfonyloxy group and a trifluoromethanesulfonyloxy group, etc.

Further, polymerization by the condensation reaction is carried out in the coexistence of a zero valent transition metal complex, and Examples of the zero valent transition metal complex include a zero valent nickel complex, a zero valent palladium complex and the like. Among these, a zero valent nickel complex is preferably used.

As the zero valent transition metal complex, commercially available products and those separately synthesized may be provided for the polymerization system and it may be generated from a transition metal compound by the action of a reducing agent. In the latter case, for example, a method of acting zinc, magnesium and the like as a reducing agent with the transition metal compound and the like are mentioned.

In any case, it is preferable from the viewpoint of the improvement of yield to add a ligand described later.

Here, Examples of the zero valent palladium complex include palladium (0) tetrakis(triphenylphosphine) and the like. Examples of the zero valent nickel complex include nickel (0) bis(cyclooctadiene), nickel (0) (ethylene) bis (triphenylphosphine), nickel (0) tetrakis (triphenylphosphine) and the like. Among these, nickel (0) bis (cyclooctadiene) is preferably used.

Further, when a reducing agent is acted to a transition metal compound to generate the zero valent transition metal complex, a divalent transition metal compound is usually used as the transition metal compound used. In particular, a divalent nickel compound and a divalent palladium compound are preferable. Examples of the divalent nickel compound include nickel chloride, nickel bromide, nickel iodide, nickel acetate, nickel acetylacetonate, nickel chloride bis(triphenylphosphine), nickel bromide bis(triphenylphosphine), nickel iodide bis (triphenylphosphine) and the like and examples of the divalent palladium compound include palladium chloride, palladium bromide, palladium iodide, palladium acetate and the like.

The reducing agent includes metals such as zinc and magnesium and alloys thereof, for example with copper, sodium hydride, hydrazine and its derivative, lithium aluminum hydride and the like. Ammonium iodide, trimethylammonium iodide, triethylammonium iodide, lithium iodide, sodium iodide, potassium iodide and the like can be used in combination, if necessary.

The use amount of the zero valent transition metal complex is usually 0.1 to 5-fold by mol based on the total amount of the monomer represented by the general formula (4) and the monomers represented by the general formulae (5) and (6) that are used if necessary. When the use amount is excessively little, molecular weight tends to be low; therefore it is preferably 1.5-fold by mol or more, more preferably 1.8-fold by mol or more and further preferably 2.1-fold by mol. Since the upper limit of the use amount is desirably 5.0-fold by mol or less because post processing tends to be troublesome when the use amount is too much.

When the reducing agent is used, the use amount of the transition metal compound is 0.1 to 1-fold by mol based on the total amount of the monomer indicated by the general formula (4) and the monomers indicated by the general formulae (5) and (6) that are used if necessary. When the use amount is excessively little, molecular weight tends to be low; therefore it is preferably 0.03-fold by mol or more. Since the upper limit of the use amount is desirably 1.0-fold by mol or less because post processing tends to be troublesome when the use amount is too much.

Further, the reducing agent is usually 0.5 to 10-fold by mol based on the total amount of the monomer indicated by the general formula (4) and the monomers indicated by the general formulae (5) and (6) that are used if necessary. When the use amount is excessively little, molecular weight tends to be low; therefore it is preferably 1.0-fold by mol or more. Since the upper limit of the use amount is desirably 10-fold by mol or less because post processing tends to be troublesome when the use amount is too much.

Examples of the above-mentioned ligand include 2,2′-bipyridyl, 1,10-phenanthroline, methylenebis(oxazoline), N,N,N′,N′-tetramethylethylenediamine, triphenylphosphine, tritolylphosphine, tributylphosphine, triphenoxyphosphine, 1,2-bisdiphenylphosphinoethane, 1,3-bisdiphenylphosphinopropane and the like, and triphenylphosphine and 2,2′-bipyridyl are preferable from the viewpoints of versatility, low price, high reactivity and high yield. In particular, since 2,2′-bipyridyl improves the yield of a polymer in combination with bis(1,5-cyclooctadiene) nickel (0), the combination is preferably used.

Further, when the ligand coexists, it is usually used by 0.2 to about 10-fold by mol based on a metal atom of the zero valent transition metal complex and preferably 1 to about 5-fold by mol.

The condensation reaction is usually carried out in the presence of solvent. Examples of the solvent include aromatic hydrocarbon solvents such as benzene, toluene, xylene, n-butylbenzene, mesitylene and naphthalene; ether solvents such as diisopropyl ether, tetrahydrofuran, 1,4-dioxane and diphenyl ether; non protic polar solvents such as N,N-dimethylformamide (DMF), N,N-dimethylacetamide (DMAc), N-methyl-2-pyrrolidone (NMP), hexamethylphosphoric triamide and dimethylsulfoxide (DMSO) which are substituted for amide solvents: aliphatic hydrocarbon solvents such as tetralin and decalin; ester solvents such as ethyl acetate, butyl acetate and methyl benzoate; halogenated alkyl solvents such as chloroform and dichloroethane, etc.

Since it is desirable that a polymer is adequately dissolved for further heightening the molecular weight of the polymer, tetrahydrofuran, 1,4-dioxane, DMF, DMAc, DMSO, NMP, toluene and the like that are good solvents for the polymer are preferable. Two or more of these can be used also in mixture. Among these, DMF, DMAc, DMSO, NMP and a mixture of 2 or more are preferably used.

The solvent is usually used by 5 to 500-fold by weight and preferably 20 to about 100-fold by weight based on the monomer.

Further, the condensation temperature is usually a range of 0 to 250° C. and preferably 10 to about 100° C. and the condensation time is usually 0.5 to about 24 hours. Among these, it is preferable to act the zero valent transition metal complex, the monomer indicated by the general formula (4) and monomers indicated by the general formulae (5) and (6) which are used if necessary, at a temperature of 45° C. or more in order to further heighten the molecular weight of a polymer prepared. The preferable action temperature is usually 45° C. to 200° C. and preferably 50° C. to about 100° C. in particular.

The method of acting the zero valent transition metal complex, the monomer indicated by the general formula (4) and monomers indicated by the general formulae (5) and (6) which are used if necessary may be a method of adding one to another and may be a method of simultaneously adding both in a reactor. When they are added, they may be added at a sweep, but it is preferably added little by little considering exothermic heat and it is preferably added in the coexistence of solvent.

After acting the zero valent transition metal complex, the monomer indicated by the general formula (4) and monomers indicated by the general formulae (5) and (6) which are used if necessary, temperature is usually kept at 45° C. to about 200° C. and preferably 50° C. to about 100° C.

A conventional method can be applied for taking out an aromatic polymer prepared by the condensation reaction from the reaction mixture. For example, the object can be taken out by adding poor solvent to precipitate a polymer and carrying out filtration and the like. Further, according to requirement, it can be purified by rinsing with water and by a usual purification method such as reprecipitation using good solvent and poor solvent.

Thus, the polyarylene polymer of the present invention is obtained and can be used as a polymer electrolyte. The polymer obtained can be identified and quantified by IR, NMR, liquid chromatography and the like and the number of the respective repeating units in the polymer chain can be determined by NMR and the like. Further, the molecular weight can be determined by gel permeation chromatography.

Further, the monomer indicated by the general formula (4) can be manufactured using a known method. For example, a method of introducing a sulfonic acid group through an alkyl group is not specifically limited, but the specific method is a method of introducing a sulfonic acid group on an aromatic ring through an alkyl group using sultone that is described in J. Am. Chem. Soc. Vol. 76, pp 5357 to 5360 (1954). Further, for example, a method of introducing a sulfonic acid group through an alkoxy group is not specifically limited, but as the specific method, for example, a compound having a hydroxyl group is reacted with an alkali metal compound and/or an organic base compound to prepare an alkali metal salt and/or an amine salt and then it can be efficiently produced by reacting it with sulfonation agents such as propane sultone and sodium bromoethanesulfonate.

Then, a case that the polyarylene polymer of the present invention is used as the separating membrane of an electrochemical device such as fuel cells is illustrated.

In this case, the polyarylene polymer of the present invention is used in the form of a film, but a method of converting it to a film is not specifically limited and, for example, a method of forming a film from a solution state is preferably used (solution casting method).

Specifically, the polyarylene polymer is dissolved in suitable solvent, the solution is coated by flow casting on a glass plate and a film is prepared by removing the solvent. The solvent used for preparation of a film is not specifically limited so far as it can dissolve the polyarylene polymer and then the solvent can be removed thereafter, and there are preferably used non protic polar solvents such as DMF, N,N-dimethylacetamide (DMAc), N-methyl-2-pyrrolidone (NMP) and DMSO; or chlorine solvents such as dichloromethane, chloroform, 1,2-dichloroethane, chlorobenzene and dichlorobenzene; alcohols such as methanol, ethanol and propanol; alkylene glycol mono alkyl ethers such as ethyleneglycol monomethyl ether, ethyleneglycol monoethyl ether, propyleneglycol monomethyl ether and propyleneglycol monoethyl ether. These can be used alone, but according to requirement, a mixture of 2 or more of solvents can be also used. Among these, DMSO, DMF, DMAc, NMP and the like are preferable because the solubility of the polymer is high.

The thickness of a film is not specifically limited, but is preferably 10 to 300 μm and preferably 20 to 100 μm in particular. A film thinner than 10 μm is occasionally inadequate in practical strength and a film thicker than 300 μm is large in membrane resistance; therefore the property of an electrochemical device tends to be lowered. The thickness of a film can be controlled by the concentration of solution and coating thickness on a substrate.

Further, a plasticizer, a stabilizer, a release agent and the like that are used for a usual polymer can be added to the block copolymer of the present invention for the purpose of improving various physical properties of the film. Further, it is also possible to prepare the complex alloy of other polymer with the copolymer of the present invention by a method of carrying out co-casting in mixture in the same solvent.

It has been also known in use for fuel cells that inorganic or organic fine particles are additionally added as a water retention agent in order to easily control water. Any of these known methods can be used.

Further, the film can be also crosslinked by irradiating electron beam, radiation ray and the like in order to improve the mechanical strength of the film. Furthermore, there have been known a method of impregnating it in a porous film or sheet and preparing a composite, a method of mixing it with fiber and pulp and reinforcing it, and the like and any of these known methods can be also used. The film thus obtained can be preferably used as the polymer electrolyte.

Then, the fuel cell of the present invention is illustrated.

The fuel cell of the present invention can be produced by connecting a catalyst and an electroconductive substance as a current collector on both sides of the polyarylene polymer film.

The catalyst is not specifically limited so far as it can activate the redox reaction of hydrogen or oxygen and known catalysts can be used, but the fine particles of platinum are preferably used. The fine particles of platinum are often used supported on particle shape or fibrous carbon such as active carbon and graphite and preferably used.

Known materials can be also used with respect to the electroconductive substance as the current collector, but porous carbon fabric, carbon nonwoven cloth or carbon paper is preferable because raw material gas is efficiently transported to the catalyst. With respect to a method of connecting the fine particles of platinum or carbon supporting the fine particles of platinum on porous carbon nonwoven cloth or carbon paper and a method of connecting it with a polymer electrolyte, for example, known methods such as a method described in J. Electrochem. Soc.: Electrochemical Science and Technology 1988, Vol. 135(9), page 2209 can be used.

Further, the polyarylene polymer of the present invention can be also used as a proton conductive material that is one component of the catalyst composition composing the catalyst layer of the solid polymer fuel cell. The fuel cell of the present invention thus produced can be used by various forms using hydrogen gas, modified hydrogen gas, methanol and the like as fuel.

The present invention will be described in detail below according to Examples, but the present invention is not limited by these Examples at all.

The molecular weight described in Examples is number average molecular weight (Mn) and weight average molecular weight (Mw) converted to polystyrene that were measured by gel permeation chromatography (GPC) under conditions described below.

GPC measurement device: HLC-8220 manufactured by TOSOH Corporation.

Column: Examples 1 to 4: KD-80M+KD-803 manufactured by Shodex Co. were connected.
Example 5; Two of AT-80M manufactured by Shodex Co. were connected.

Column temperature: 40° C.

Mobile phase solvent: DMAc (LiBr was added so as to be 10 mmol/dm³.)

Solvent flow rate: 0.5 mL/min

Further, the measurement of proton conductivity used a film obtained by a solution casting method using the solvent described in respective Examples and was measured by an alternate current method under the conditions of a temperature of 80° C. and a relative humidity of 90%. The ion exchange capacity (IEC) was determined by a titration method.

Preparation of Membrane Electrode Assembly

To 6 mL of Nafion solution (5% by weight, manufactured by Sigma-Aldrich Co.), 603 mg of carbon supporting platinum (manufactured by E-tech Co.) that supported 30% by weight of platinum and 13.2 mL of ethanol were added and the mixture was adequately stirred to prepare catalyst layer solution. The catalyst layer solution was coated on a gas diffusion layer (carbon cloth) by screen printing so that the carrying density of platinum was 0.6 mg/cm² and the solvent was removed to prepare a membrane electrode assembly.

Preparation of Fuel Cell

The commercially available cell of ElectroChem. Inc. was used. A separator made of carbon on which grooves for gas channel were formed by cutting work and an end plate were arranged at both outsides of the membrane electrode assembly and a fuel cell with an effective membrane area of 5 cm² was assembled by clinching it with bolts.

Evaluation of Power Generation Performance of Fuel Cell

The fuel cell was kept at 80° C. and humidified hydrogen to anode and humidified air to cathode were fed so that back pressure at the gas outlet of the cell was 0.1 MPaG. Humidification was carried out by passing gas in a bubbler, the water temperature of a bubbler for hydrogen was set at 90° C. and the water temperature of a bubbler for air was set at 80° C. The gas flow rate of hydrogen was set at 300 mL/min and the gas flow of air was set at 1000 mL/min.

### Synthesis Example 1

### Synthesis of sodium 3-(2,5-dichlorophenoxy)propanesulfonate

Under argon atmosphere, 150 ml of DMAc, 75 ml of toluene, 24.15 g (148.2 mmol) of 2,5-dichlorophenol and 47.10 g (444.4 mmol) of sodium carbonate were charged in a flask, the mixture was stirred under heating, dehydration was carried out under the azeotropic condition of toluene with water and then, toluene was removed by distillation. After cooling to the room temperature, 50.00 g (222.2 mmol) of sodium 3-bromopropanesulfonate was added, the temperature was raised to 100° C. and it was stirred at the same temperature for 10 hours. After cooling, the solid was removed by vacuum filtration, a large quantity of chloroform was added to the filtrate obtained and white solid precipitated was separated by filtration. Further, 35.2 g (yield: 77%) of sodium 3-(2,5-dichlorophenoxy)propanesulfonate was obtained by a recrystallization method.

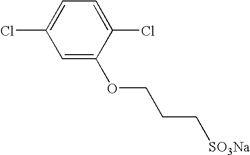

### Example 1

Under argon atmosphere, 70 ml of DMSO, 2.50 g (8.14 mmol) of sodium 3-(2,5-dichlorophenoxy)propanesulfonate obtained in Synthesis Example 1, 5.11 g (20.35 mmol) of 2,5-dichlorobenzophenone and 13.63 g (87.30 mmol) of 2,2′-bipyridyl were charged in a flask, the mixture was stirred, and temperature was raised to 60° C. Then, 21.8 g (79.36 mmol) of nickel (0) bis(cyclooctadiene) was added thereto, the temperature was raised to 80° C. and it was stirred at the same temperature for 9 hours. After cooling, the reaction solution was poured into a large quantity of 4N hydrochloric acid to precipitate a polymer, it was separated by filtration, rinsing with water was carried out until the filtrate was neutral and then, it was dried under reduced pressure to obtain 5.38 g of objective polyphenylenesulfonic acids.

Mn=20000 and Mw=300000
IEC=1.45 meq/g (calculated as a/(a+b)=0.28)

Proton conductivity=1.75×10⁻² S/cm (DMSO was used for preparing a cast film)

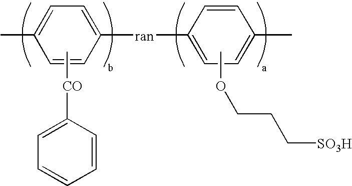

### Example 2

Under argon atmosphere, 85 ml of DMSO, 5.00 g (16.28 mmol) of sodium 3-(2,5-dichlorophenoxy)propanesulfonate obtained in Synthesis Example 1, 2.03 g of the following polyether sulfone which is chloro type at terminal 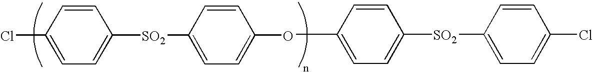
(SUMIKA EXCEL PES5200P manufactured by Sumitomo Chemical Co., Ltd. Mn=5.44×10⁴ and Mw=1.23×10⁵) and 9.83 g (62.96 mmol) of 2,2′-bipyridyl were charged in a flask, the mixture was stirred, and temperature was raised to 60° C. Then, 15.74 g (57.23 mmol) of nickel (0) bis(cyclooctadiene) was added thereto, the temperature was raised to 80° C. and it was stirred at the same temperature for 20 hours. After cooling, the reaction solution was poured into a large quantity of 4N hydrochloric acid to precipitate a polymer, it was separated by filtration, rinsing with water was carried out until the filtrate was neutral and then, it was dried under reduced pressure to obtain 4.32 g of objective polyphenylenesulfonic acids.

Mn=180000 and Mw=400000
IEC=2.32 meq/g (calculated as (a/(a+((n+1)×b)=0.51)

Proton conductivity=2.04×10⁻¹ S/cm (DMSO was used for preparing a cast film) 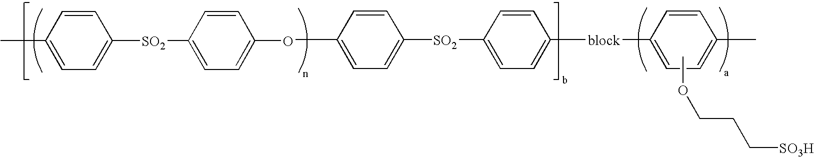
Result of evaluation of power generation performance of fuel cell
When electric current density was 0.50 A/cm², the voltage of cell was 0.70 V.
When electric current density was 1.00 A/cm², the voltage of cell was 0.54 V.

### Example 3

Under argon atmosphere, 70 ml of DMSO, 5.50 g (17.92 mmol) of sodium 3-(2,5-dichlorophenoxy)propanesulfonate obtained in Synthesis Example 1, 0.50 g (1.99 mmol) of 4,4′-dichlorobenzophenone and 10.09 g (64.61 mmol) of 2,2′-bipyridyl were charged in a flask, the mixture was stirred, and temperature was raised to 60° C. Then, 16.16 g (58.74 mmol) of nickel (0) bis(cyclooctadiene) was added thereto, the temperature was raised to 80° C. and it was stirred at the same temperature for 6 hours. After cooling, the reaction solution was poured into a large quantity of 4N hydrochloric acid to precipitate a polymer, it was separated by filtration, rinsing with water was carried out until the filtrate was neutral, rinsing with acetone was carried out and then, it was dried under reduced pressure to obtain 4.22 g of objective polyphenylenesulfonic acids.

Mn=30000 and Mw=580000
IEC=3.95 meq/g (calculated as a/(a+b)=0.82)

Proton conductivity=4.64×10⁻¹ S/cm (DMSO was used for preparing a cast film)

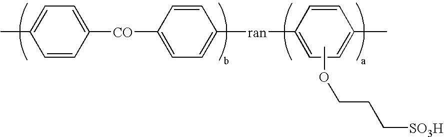

### Synthesis Example 2

### Synthesis of sodium 3-(2,5-dichlorophenoxy)ethanesulfonate

Under argon atmosphere, 150 ml of DMAc, 75 ml of toluene, 11.84 g (72.6 mmol) of 2,5-dichlorophenol and 23.10 g (217.9 mmol) of sodium carbonate were charged in a flask, the mixture was stirred under heating, dehydration was carried out under the azeotropic condition of toluene with water and then, toluene was removed by distillation. After cooling to the room temperature, 23.00 g (109.0 mmol) of sodium 3-bromoethanesulfonate was added, the temperature was raised to 100° C. and it was stirred at the same temperature for 10 hours. After cooling, the solid was removed by vacuum filtration, a large quantity of chloroform was added to the filtrate obtained and white solid precipitated was separated by filtration. Further, 14.3 g (yield: 67%) of sodium 3-(2,5-dichlorophenoxy)ethanesulfonate was obtained by a recrystallization method.

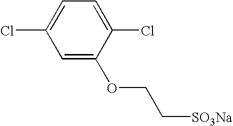

### Example 4

Under argon atmosphere, 86 ml of DMSO, 5.00 g (17.06 mmol) of sodium 3-(2,5-dichlorophenoxy)ethanesulfonate obtained in Synthesis Example 2, 2.27 g of the following polyether sulfone which is chloro type at terminal 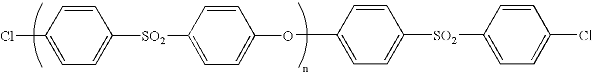
(SUMIKA EXCEL PES5200P manufactured by Sumitomo Chemical Co., Ltd. Mn=5.44×10⁴ and Mw=1.23×10⁵) and 10.31 g (65.99 mmol) of 2,2′-bipyridyl were charged in a flask, the mixture was stirred, and temperature was raised to 60° C. Then, 16.50 g (59.99 mmol) of nickel (0) bis(cyclooctadiene) was added thereto, the temperature was raised to 80° C. and it was stirred at the same temperature for 17 hours. After cooling, the reaction solution was poured into a large quantity of 4N hydrochloric acid to precipitate a polymer, it was separated by filtration, rinsing with water was carried out until the filtrate was neutral and then, it was dried under reduced pressure to obtain 4.73 g of objective polyphenylenesulfonic acids.

Mn=93000 and Mw=186000
IEC=2.35 meq/g (calculated as (a/(a+((n+1)×b)=0.47)
Proton conductivity=1.44×10⁻¹ S/cm (DMSO was used for preparing a cast film)

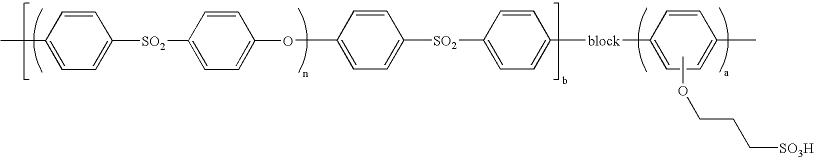

### Synthesis Example 3

### Synthesis of sodium 3-(2,5-dichlorophenoxy)butanesulfonate

Under argon atmosphere, 150 ml of DMAc, 75 ml of toluene, 20.00 g (122.7 mmol) of 2,5-dichlorophenol and 39.01 g (368.1 mmol) of sodium carbonate were charged in a flask, the mixture was stirred under heating, dehydration was carried out under the azeotropic condition of toluene with water and then, toluene was removed by distillation. After cooling to the room temperature, 25.06 g (184.1 mmol) of butane sultone was added, the temperature was raised to 80° C. and it was stirred at the same temperature for 10 hours. After cooling, the solid was removed by vacuum filtration, a large quantity of chloroform was added to the filtrate obtained and white solid precipitated was separated by filtration. Further, 38.7 g (yield: 98%) of sodium 3-(2,5-dichlorophenoxy)butanesulfonate was obtained by a recrystallization method.

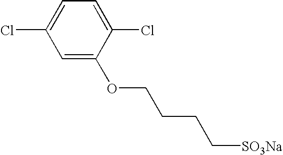

### Example 5

Under argon atmosphere, 85 ml of DMSO, 5.00 g (15.57 mmol) of sodium 3-(2,5-dichlorophenoxy)butanesulfonate obtained in Synthesis Example 3, 1.73 g of the following polyether sulfone which is chloro type at terminal 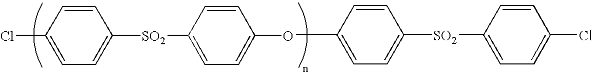
(SUMIKA EXCEL PES5200P manufactured by Sumitomo Chemical Co., Ltd. Mn=5.44×10⁴ and Mw=1.23×10⁵) and 8.06 g (51.62 mmol) of 2,2′-bipyridyl were charged in a flask, the mixture was stirred, and temperature was raised to 60° C. Then, 12.91 g (46.92 mmol) of nickel (0) bis(cyclooctadiene) was added thereto, the temperature was raised to 80° C. and it was stirred at the same temperature for 4 hours. After cooling, the reaction solution was poured into a large quantity of 4N hydrochloric acid to precipitate a polymer, it was separated by filtration, rinsing with water was carried out until the filtrate was neutral and then, it was dried under reduced pressure to obtain 5.21 g of objective polyphenylenesulfonic acids.

Mn=130000 and Mw=250000
IEC=2.67 meq/g (calculated as (a/(a+((n+0.61)

Proton conductivity=2.98×10⁻¹ S/cm (DMSO was used for preparing a cast film)

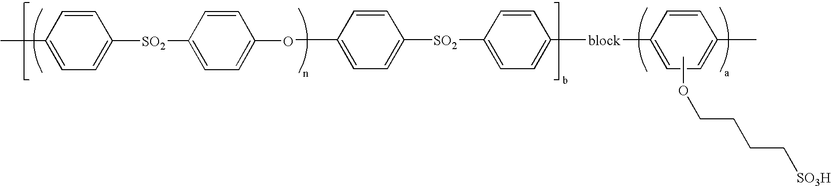

### INDUSTRIAL APPLICABILITY

The polyarylene polymer of the present invention exhibits excellent performance in the properties of proton conductivity and the like as a polymer electrolyte, in particular, the proton conductive membrane of solid polymer fuel cells. As a result, when it is used as the proton conductive membrane of solid polymer fuel cells, it is considered that it exhibits high power generation property and the polyarylene polymer of the present invention is industrially advantageous as the polymer electrolyte.

1. A polyarylene polymer having a repeating unit represented by the following general formula (1) 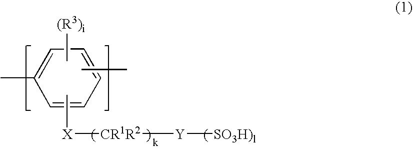
(Wherein X represents any of a direct bond, —O—, —S—, —SO—, —SO₂— or —CO—, Y represents a direct bond, a divalent or trivalent aromatic group, R¹ and R² represent a hydrogen atom or a fluorine atom independently, R³ represents a sulfonic acid group, an alkyl group having 1 to 10 carbons or an aryl group having 6 to 18 carbons which may be optionally substituted, i represents a number of 0 to 3, k represents a number of 1 to 12, l represents 1 when Y is a direct bond or divalent aromatic group and l represents 2 when Y is a trivalent aromatic group.).

2. A polymer according to claim 1, wherein 90% or more of the repeating unit represented by the general formula (1) is bonded at pare-position.

3. A polymer according to claim 1, further having at least one of repeating units represented by the following general formulae (2) and (3) 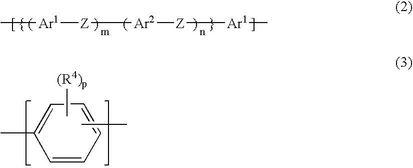
(Wherein Ar¹ and Ar² represent a divalent aromatic group independently, hereat, the divalent aromatic group may be optionally substituted with an alkyl group having 1 to 10 carbons, an aryl group having 6 to 18 carbons or a sulfonic acid group, Z represents any of —O—, —SO₂— or —CO—, m represents a number of 1 or more, n represents a number of 0 or more, R⁴ represents a sulfonic acid group, an alkyl group having 1 to 10 carbons, an aryl group having 6 to 18 carbons which may be optionally substituted or an acyl group having 2 to 20 carbons independently and p represents a number of 0 to 4.).

4. A polymer according to claim 3, wherein 90% or more of the repeating unit represented by the general formula (3) is bonded at para-position.

5. A polymer according to claim 1, wherein Y is a direct bond.

6. A polymer according to claim 1, wherein i is 0.

7. A polymer according to claim 1, wherein ion exchange capacity is from 0.5 meq/g to 4 meq/g.

8. A polymer according to claim 1, being a random copolymer or a block copolymer.

9. A polymer electrolyte wherein the polymer according to claim 1, is an effective component.

10. A polymer electrolyte membrane comprising the polymer electrolyte according to claim 9.

11. A catalyst composition comprising the polymer electrolyte according to claim 9.

12. A polymer electrolyte fuel cell comprising at least one selected from the polymer electrolyte according to claim 9.

13. A polymer electrolyte fuel cell comprising at least one selected from the polymer electrolyte membrane according to claim 10.

14. A polymer electrolyte fuel cell comprising using at least one selected from the catalyst composition according to claim 11.
